(19) United States
(12) Patent Application Publication
(10) Pub. No.: US 2005/0086349 A1
(43) Pub. Date: Apr. 21, 2005

(54) Methods and apparatus for offloading TCP/IP processing using a protocol driver interface filter driver

(76) Inventor: Nagarajan Subramaniyan, Sunnyvale, CA (US)

Correspondence Address: IPSG, P.C., P.O. BOX 700640, SAN JOSE, CA, 95170-0640, US

(21) Appl. No.: 10/687,189

(22) Filed: Oct. 16, 2003

(51) Int. Cl. G06F 15/16

(52) U.S. Cl. 709/230

(57) ABSTRACT

A method for optimizing a network connection between a first device and a second device, the first device comprising a first packet protocol and a second packet protocol, the first packet protocol comprising a connection setup portion, the second protocol comprising a data transfer portion. The method includes initiating the network connection from the first device to said second device using the first packet protocol. The method further includes receiving an acknowledgement from the second device; and, initiating a data transfer between the first device and the second using the second packet protocol.

### BACKGROUND OF THE INVENTION

The present invention relates in general to computer networking technologies and in particular to methods and apparatus for optimizing a TCP connection through the use of a transport protocol driver interface filter driver.

TCP/IP is the language of the Internet. The packet is the fundamental unit of TCP/IP. Packets are discrete units of data that is sent across a network between two devices. In the case of the Internet, the network is connectionless. That is, there is no pre-determined path for the packets to follow. For example, an application on a server device, such as a web server, would use the HTTP/HTTPS protocol, which is built on TCP/IP, to transmit information to an application on a client device, such as a web browser. When the browser finally receives the necessary packets, it renders the web page.

Network protocols, such as TCP/IP, are usually implemented as a series of discrete layers, or functional components, which can be interchanged. This set of layers, commonly called a stack, is conceptually much like a child's set of blocks. Each layer interlocks with it neighbor above and below. And any given layer provides a service for the layer above it, or likewise, consumes a service from the layer below it.

The top-most layer is the user application itself, conceptually the end customer of the network stack. An example is Internet browser, such as Netscape. The bottom most layer is usually a network interface card (NIC) that physically connects the device to the network. It is this bottom layer that converts the programmatic information of the operating system (OS) into electrical signals that can propagate over a physical medium, as in Ethernet, or through electro-magnetic radiation, as in 802.11b.

Implementing a network protocol in layers has many advantages. For instance, it makes the overall stack flexible since the network protocol can be evolved to accommodate new uses and applications, not foreseen at the protocol's creation. It can also increase reliability, since discrete functionality is isolated into separate components, thereby simplifying protocol development and enhancement.

TCP/IP comprises two of the layers in the center, between the user application and the NIC. The higher layer is called Transmission Control Protocol (TCP), while the lower layer is called Internet Protocol (IP). TCP converts data from the user application into a series of packets, manages the reliable transmission of those packets, and then re-assembles the packets in proper order as they arrive at the destination. IP, on the other hand, is only responsible for the address part of each packet (i.e., routing the data from the sender to the receiver). It provides only a “best-effort,” and is unconcerned with reliability. For example, TCP directs IP to send a packet and then waits for an acknowledgment, or ACK, from the target device before sending the next packet. If the ACK is not received within a certain amount of time, TCP directs IP to retransmit the packet. The combination of TCP and IP form TCP/IP, perhaps the most common protocol on the Internet today.

TCP/IP connections are established, and the parameters of the connection negotiated, using a handshake method. A handshake is the exchange of information between two devices, which results in an agreement about how to proceed with the connection. Aside from the data, or payload, portion of each TCP packet, there is also a data structure used for control of the TCP connection (“TCP header”). Among the various control elements is a flags field that defines the type of the TCP packet: ACK, SYN, FIN, RST, URG and PuSH. If the ACK control bit is set, the receiver acknowledges to the sender that the previous set of packets were correctly received. If the SYN control bit is set, the sending device wishes to establish a new TCP connection. If the FIN control bit is set, then that packet is the last packet of the TCP connection from that direction. And if the RST control bit is set, then the sender is notifying the receiver that the connection must be ended prematurely. Normally, a packet is referred to by the control bits within it that have been set. For instance, a packet with the ACK control bit set is called an ACK packet. Almost all TCP data packets have ACK bit set.

A TCP/IP connection is established after a 3 way handshake of TCP/IP packets exchanged between the sender and the receiver. To establish a TCP/IP connection, a client requests a TCP connection from a server by sending a SYN packet with the appropriate options (i.e., maximum packet segment size, packet timestamp, receive window size and scale, etc.). If the server desires to accept the connection, it responds by sending a SYN+ACK packet back to the client. This SYN+ACK packet may have any options that it can support. The SYN+ACK packet both acknowledges that the packet was received, and that the server will accept the TCP connection. The client then sends a single ACK packet back to the server, acknowledging the receipt of the previous packet, and establishing the TCP connection.

Another relatively recent enhancement to TCP/IP was the introduction of Internet Protocol Security, or IPsec. Unlike earlier security approaches that required modification of the user application, IPsec is incorporated into TCP/IP itself as a layer over the IP protocol by modifying packet data structure and encryption of packet payload. IPsec is especially useful for implementing virtual private networks and for remote user access through dial-up connection to private networks.

Early computer operating systems, such as the first few versions of Microsoft Windows, did not include networking functionality. End users had to install third-party network stack programs along with a NIC. This created some problems as one vendor's TCP/IP implementation may not have been entirely compatible with another's NIC. Enabling networking in these computers was problematic and frustrating.

Most modern operating systems, however, now include an integrated network stack. By incorporating networking functionality into the operating system, compatibility problems have been reduced. Some operating systems, such as Linux, still allow sophisticated end-users almost unlimited flexibility to reconfigure and integrate third party programs, stacks, and drivers. Others, namely Microsoft Windows, precluded this flexibility. Microsoft's integration of the network stack discouraged the creation of any networking solutions that involved its modification, since they would not be officially supported.

Referring now to FIG. 1, a common prior art implementation of a TCP/IP stack is shown. In this example, the TCP/IP stack is integrated into the operating system, which is installed on a device, like a PC. The device contains a network interface card, NIC H/W 136, which allows it to be electrically connected to the network. Also, installed is a user application 102, for which TCP/IP is providing networking services.

Conceptually, there are two operational modes or spaces within most operating systems. The space, in which TCP/IP functions, as well as where most other software drivers reside, is kernel mode. In kernel mode, all applications have direct access to all underlying device resources, such as memory and network interface cards, with minimal system protection. That is, a faulty program will likely cause the computer to crash.

The space in which most user applications function is the user mode. In user mode, each application is unaware of the others, and believes it has full unrestricted access to all computer resources, although in reality, this is a fiction. The operating system presents this abstraction to user applications to simplify application programming, as well as to protect running applications from each other.

In order to keep track of system resources and activities, such as the TCP/IP connection itself, the operating system uses handles. A handle is a unique identifier or pointer that is used to access an object, similar to an index number. Whenever a program or resource needs to access another resource, its presents the handle to the appropriate application programming interface, or API. For programmatic and security reasons, the same resource can have a different handle depending if it is accessed in user mode (i.e. by the application) or in kernel mode (i.e., by a driver or resource). In the case of TCP/IP, a given connection has a user handle in user mode (socket handle), and a transport handle (connection context) in kernel mode. In general, in a layered driver architecture, each layer and the interface between each layer can be defined to use its own handles for a given connection/object.

In this implementation, a user application 102, such as a web browser, initiates a TCP connection through the HTTP/HTTPS protocol, which is a user mode library built on top of user mode sockets library 106. A socket is an abstraction, containing a set of networking services, and implemented as a set of APIs (i.e., Sockets API in Unix and Linux, and WinSOCK2 in Microsoft Windows), that is presented to the user application 102. This greatly simplifies software development since the application need only concern itself with the socket programming, instead of the complexities of a TCP connection. The user application 102, communicates to the socket library 106, through socket API 104. The socket library 106, in turn crosses the kernel mode boundary 110, connects to the kernel mode socket library 112 through 108, and interfaces with the appropriate network drivers on behalf of the user application 102.

In general, operating systems have a driver for each network protocol that is supported. In this case, there is shown an AppleTalk protocol driver 120, a TCP/IP protocol driver 122, and another protocol driver 118. AppleTalk is a set of local area network communication protocols originally created for Apple computers. The kernel mode socket library is connected to the AppleTalk protocol driver at 114. The kernel mode socket library is connected to the TCP/IP protocol driver at protocol interface 116. The other protocol driver 118 represents any additional network protocols that have been installed in the operating system. In general each other protocol driver 118 may have its own user mode helper library 101 that exposes a set of APIs for the user application 102, and a kernel mode helper library 111 that connects the user mode helper library 101 to the other protocol driver 118.

These drivers, in turn, connect to a set of kernel functions/interface library 126 that can be used by all drivers. The AppleTalk protocol driver is connected to the kernel functions/interface library 126 at 123. The TCP/IP protocol driver is connected to the kernel functions/interface library 126 at 124. And the other protocol driver is connected to the kernel functions/interface library 126 at 121.

Kernel functions/interface library 126 connects to the NIC driver 130 at 128. NIC driver 130 allows the kernel functions/interface library 126 to manipulate and control NIC H/W 136, through HAL (Hardware Abstraction Layer) 135, in order to establish a TCP connection.

HAL, or hardware abstraction layer, ultimately controls all direct access to hardware resources, such as a NIC. HAL is written entirely in low level hardware dependent code, and is the lowermost portion of an operating system. The NIC driver 130 is connected to HAL 135 at 132. The HAL 135, in turn, is connected to the NIC HI/W at 136.

Processing IP packets in operating system software is very common, as in FIG. 1. However, since a software application generally requires more machine instructions than a hardware application for a given task, software processing is generally slower than its hardware equivalent. In this case, the processing of IP packets is particularly CPU intensive, which means it requires a large amount of machine instructions. Multiple simultaneous TCP connections can overly tax the CPU, thereby slowing down IP packet processing, and subsequently reducing overall network performance.

Referring now to FIG. 2, a possible solution to optimizing a TCP connection is shown. In this example, a replacement TCP/IP protocol driver 252 is used which can be more efficient at processing IP packets than the OS supplied TCP/IP protocol driver 222.

As in FIG. 1, user application 202 initiates a TCP connection by communicating to the socket library 206, through socket API 204. The socket library 206, in turn crosses the kernel mode boundary 210, connects to the kernel mode socket library 212 at 208.

In this example, three drivers shown: an OS supplied TCP/IP protocol driver 222, a replacement TCP/IP protocol driver 252, and another protocol driver 218. The kernel mode socket library is connected to the OS supplied TCP/IP protocol driver at 216, and the replacement TCP/IP protocol driver 252 at 250. As before in FIG. 1, the other protocol driver represents any additional network protocols that have been installed in the operating system. The other protocol driver 218 is connected to its own user mode helper library 201 at 220, and a kernel mode helper library 211 at 219.

These drivers, in turn, connect to a set of kernel functions/interface library 226 that can be used by all drivers. The OS supplied TCP/IP protocol driver 222 is connected to the kernel functions/interface library 226 at 224. The replacement TCP/IP protocol driver 252 is connected to the kernel functions/interface library 226 at 254. And the other protocol driver is connected to the kernel functions/interface library 226 at 221.

The kernel functions/interface library 226 connects to the NIC driver 230 at 228. The NIC driver 230 allows the kernel functions/interface library 226 to manipulate and control the NIC H/W 236, through HAL 235, in order to establish a TCP connection. The NIC driver 230 is connected to HAL 235 at 232. The HAL 235, in turn, connects to the NIC H/W at 236.

Although FIG. 2 shows a potential optimization of TCP/IP, its practical advantage is suspect since it is still largely implemented in software, while adding complexity to the operating system. As previously described in FIG. 1, the processing of IP packets is particularly CPU intensive, which means the CPU must process a large amount of machine instructions. Multiple simultaneous TCP connections can overly tax the CPU, thereby slowing down IP packet processing, and subsequently reducing overall network performance.

Complexity is also increased since not all functions are available in the replacement TCP/IP protocol driver 252, requiring some TCP connections to still be handled by the OS-supplied TCP/IP protocol driver 222. For example, TCP connections that involve security, such as IPsec, need to be handled by the OS-supplied TCP/IP protocol driver 222, in order to insure communication integrity. In addition, depending on the implementation and the underlying operating system, a replacement TCP/IP protocol driver may have to coexist with the OS-supplied protocol, or it has to completely replace the OS-supplied protocol. In either case, there are further issues of software compatibility with all the OS-supplied network tools and applications as well as with other versions of the operating system.

In short, having multiple protocol drivers coexisting leads to several practical difficulties and bugs. For example, the NIC H/W 236 monitors incoming packets, and determines the appropriate driver by the protocol type, such as AppleTalk or TCP/IP. In this case, there are two different drivers for the same TCP protocol. This situation can be solved by further operating system modifications. This added complexity can potentially reduce any optimization gains and can lead to more software bugs and interoperability/compatibility issues.

In addition to the above issues, there are other pitfalls. TCP/IP maintains live information in a database, such as routing tables etc., which are dynamically updated and used in opening new connections or modifying existing connection parameters. Having more than one TCP/IP protocol leads to conflicts in these databases which in turn leads to less than ideal network conditions and connection failures.

In view of the foregoing, it is desirable to come up with methods and apparatus for optimizing the transfer of data packets across a network, in order to improve application performance and reduce unnecessary network congestion, without modification to the TCP/IP protocol driver that is supplied with the operating system.

### SUMMARY OF THE INVENTION

The invention relates, in one embodiment, to a method for optimizing a network connection between a first device and a second device, the first device comprising a first packet protocol and a second packet protocol, the first packet protocol comprising a connection setup portion, the second protocol comprising a data transfer portion. The method includes initiating the network connection from the first device to set second device using the first packet protocol. The method further includes receiving an acknowledgement from the second device; and, initiating a data transfer between the first device and the second using the second packet protocol.

The invention relates, in another embodiment, to an apparatus for optimizing a network connection between a first device and a second device, the first device comprising a first packet protocol and a second packet protocol, the first packet protocol comprising a connection setup portion, the second protocol comprising a data transfer portion. The apparatus includes a means for initiating the network connection from the first device to set second device using the first packet protocol; The apparatus further includes a means for receiving an acknowledgement from the second device; and, a means for initiating a data transfer between the first device and the second using the second packet protocol.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a common prior art implementation of a TCP/IP stack;

FIG. 2 depicts a possible solution to optimizing a TCP connection through a replacement TCP/IP protocol driver;

FIG. 3 depicts, in accordance with one aspect of the present invention, a simplified diagram of a network stack, comprising the OS supplied TCP/IP protocol driver, in which some of the TCP/IP packet processing has been offloaded to offload hardware;

FIG. 4A depicts, in accordance with another aspect of the present invention, a simplified diagram showing a sequence transactions for a TCP connection, in which data is sent from a client, which comprises one embodiment of the present invention, to a server;

FIG. 4C depicts, in accordance with another aspect of the present invention, a simplified diagram showing a sequence steps used by the TCP/IP filter driver to monitor and offload an outgoing TCP connection; and,

FIG. 4D depicts, in accordance with another aspect of the present invention, a simplified diagram showing a sequence steps used by the NIC driver to monitor and offload an incoming packet.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

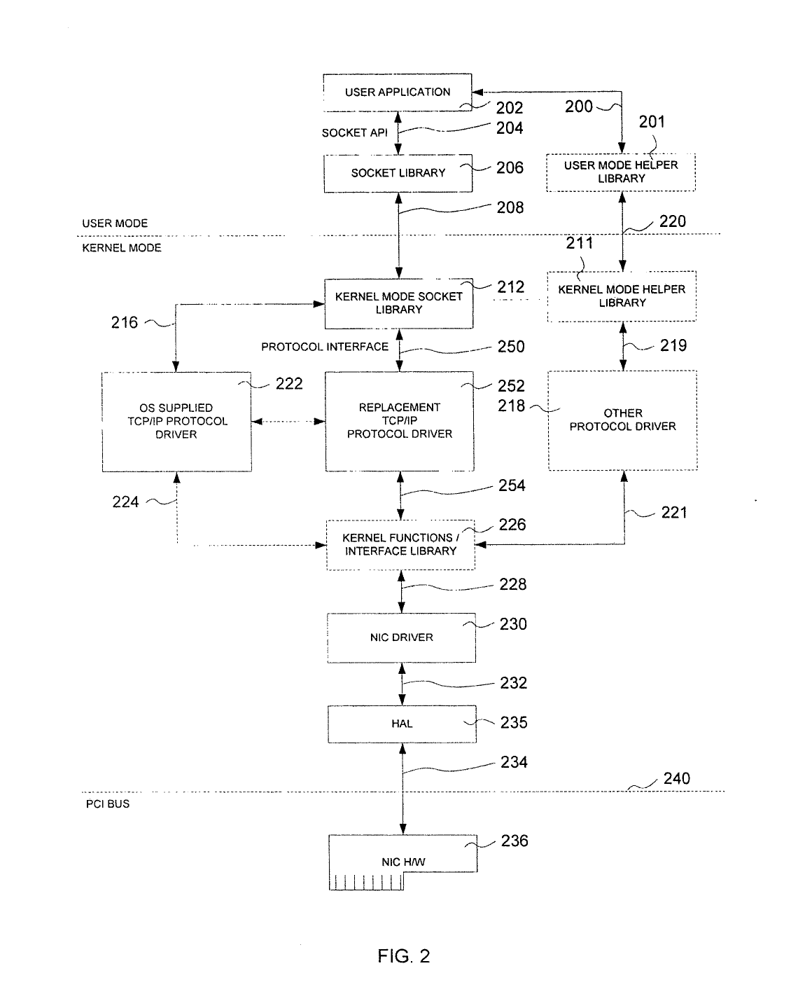

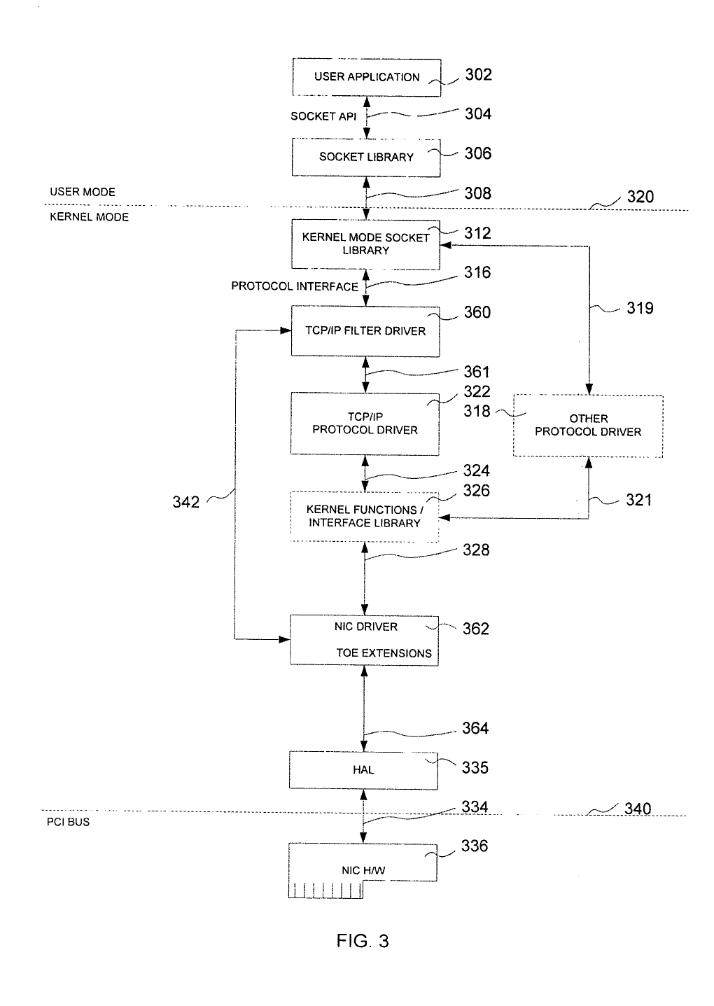

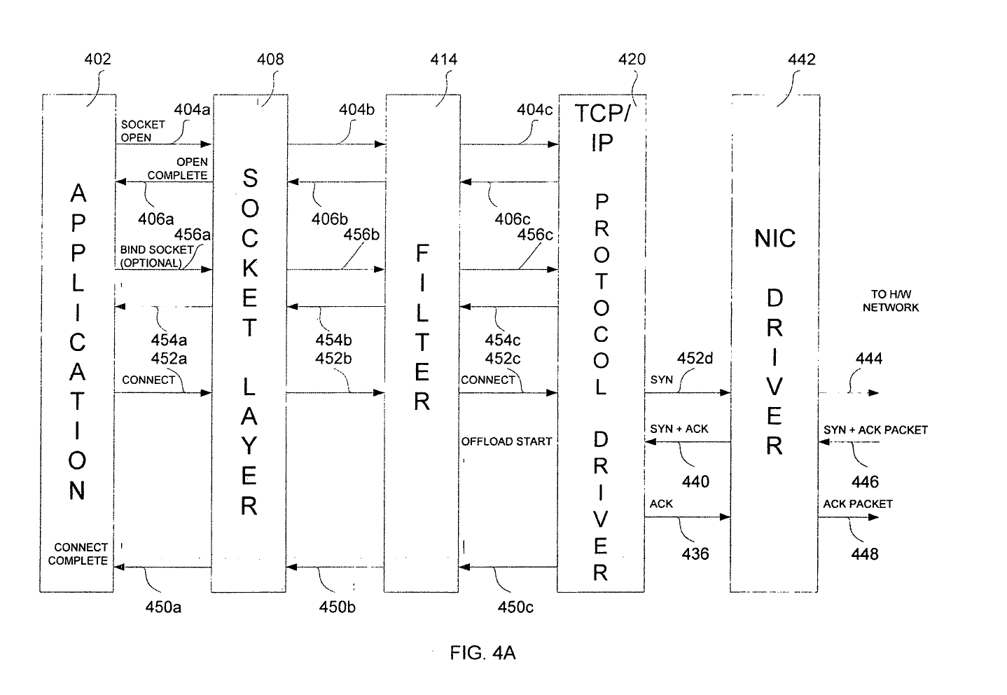

FIG. 3 illustrates, in accordance with one aspect of the present invention, a simplified diagram of a network stack, comprising the OS supplied TCP/IP protocol driver, in which some of the TCP/IP packet processing has been offloaded to offload hardware. Unlike the possible solution of FIG. 2, a replacement TCP/IP protocol driver is not required. Instead, the present invention allows the OS supplied TCP/IP protocol driver 322 to first establish the TCP connection, and then process TCP/IP packets in offload hardware, if possible.

A new element, a TCP/IP filter driver 360, is inserted into the network stack between the kernel mode socket library 312 and the TCP/IP protocol driver 322. This driver, in addition to a modified NIC driver with TOE extensions 362, monitors all TCP connections, offloading the processing of IP packets to offload hardware whenever possible. Certain connections, such as IPsec, cannot be easily offloaded because of factors such as complexity and security, and can instead be handled through the OS supplied TCP/IP protocol driver 322. In this embodiment, the offload hardware is located on NIC H/W 336.

The TCP/IP Filter driver enables the offloading of a TCP/IP connection to the offload hardware with the help of the NIC driver (with TOE extensions). The TOE extensions of the NIC driver include the interface between the NIC driver and the TCP/IP protocol filter driver. This interface provides several APIs for data transfer on an offloaded TCP/IP connection as well as to monitor and adjust the connection parameters of an offloaded TCP/IP connection and collection statistics on all the offloaded TCP/IP connections from the TCP offload capable NIC hardware.

The decision to offload TCP/IP connections from the software stack can happen in several ways and is implementation dependant. In one embodiment, the decision to offload a TCP/IP connection is made at the protocol filter driver based on system hardware capabilities and the system routing tables etc. In another embodiment, the decision to offload a TCP/IP connection is made at the NIC driver, with the help of the filter driver, based on detecting the connection establishment handshake and handshake termination.

As a connection's data stream enters the TCP stack from the user application 302, it is examined at the TCP/IP filter driver 360. If this connection is already offloaded, the TCP/IP filter driver 360 redirects the data to the offload hardware. This offload hardware converts the data stream into a series of ordered TCP/IP packets, which are then sent to the NIC H/W 336 to be transmitted to the destination device. Likewise, ordered TCP/IP packets entering the TCP stack from the destination device are received at the NIC H/W 336, intercepted at the NIC driver with TOE extensions, and redirected to the TCP/IP Protocol Filter Driver. In this case, the offload hardware re-assembles the ordered TCP/IP packets back into a data stream, which is then sent to the TCP/IP filter driver 360, and then forwarded to the user application 302. TOE, or TCP Offload Engine, is hardware (or a software module) that is capable of independently managing TCP/IP connections, doing all the TCP/IP processing usually done by the host operating system TCP/IP stack.

Referring back to FIG. 3, user application 302, communicates to the socket library 306, through socket API 304. The socket library 306, in turn crosses the kernel mode boundary 320, connects to the kernel mode socket library 312 at 308, and interfaces with the appropriate network drivers on behalf of the user application 302.

The kernel mode socket library 312 is connected to the TCP/IP filter driver 360 through connection 316. The TCP/IP filter driver 360, in turn, is connected to the TCP/IP protocol driver 322 through connection 361. And the TCP/IP protocol driver 322 is connected to the kernel functions/interface library 326 through connection 324.

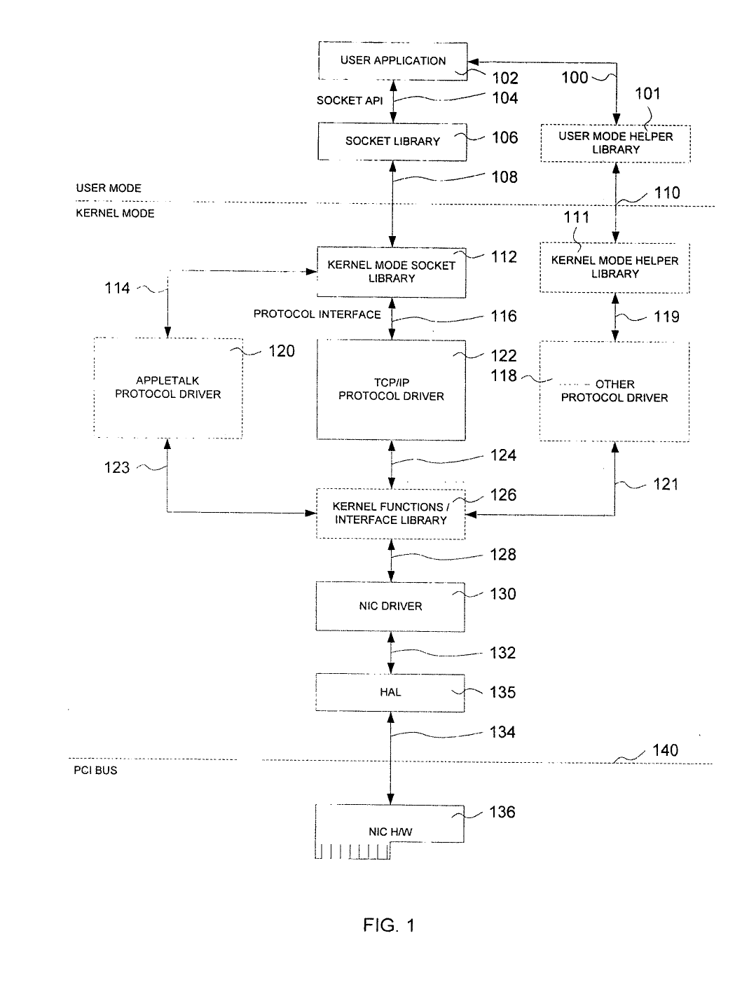

Other non-TCP/IP protocols would not use the TCP/IP filter driver 360, and instead would connect to the kernel mode socket library 312 through connection 319, and the kernel functions/interface library 326 through connection 321, as in the common prior art implementation shown FIG. 1. Sockets libraries usually only support IP based protocols including TCP/IP and UDP. Other protocols may have their own user mode API libraries that the application may use to access the network using those protocols.

The kernel functions/interface library 326 connects to the NIC driver with TOE extensions 362 at 328. The NIC driver with TOE extensions 362 connects to HAL 335, at 362. And the HAL 335, in turn, connects to the NIC H/W 336 at 334.

Unlike the common prior art implementation of FIG. 1, or the possible solution shown in FIG. 2, the present invention allows the transparent offloading of IP packet processing from software to the offload hardware, without modification of the TCP/IP protocol driver that is supplied with operating system. This can increase network performance without significantly increasing driver complexity.

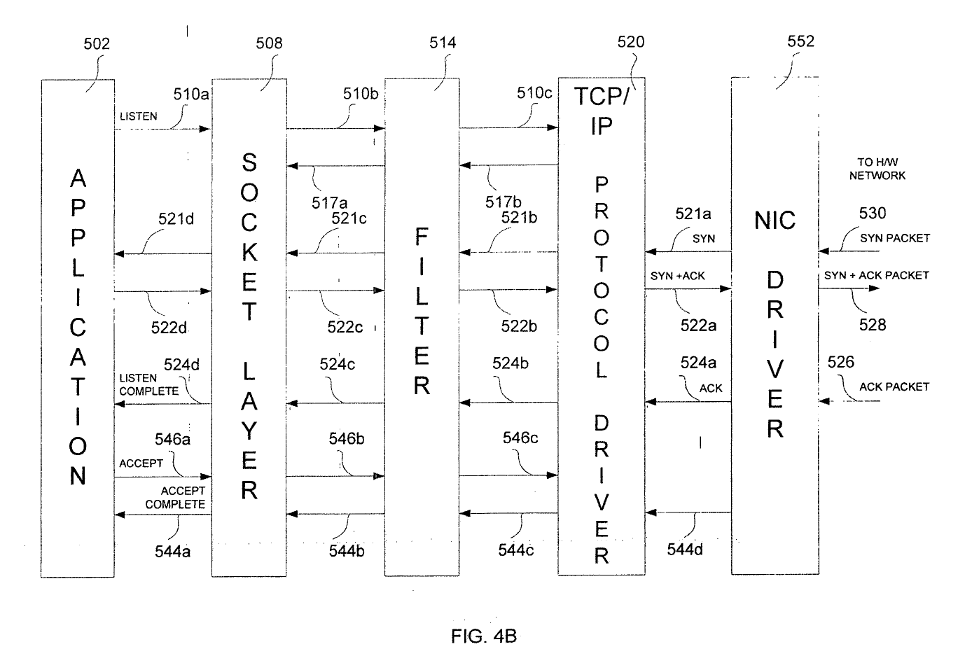

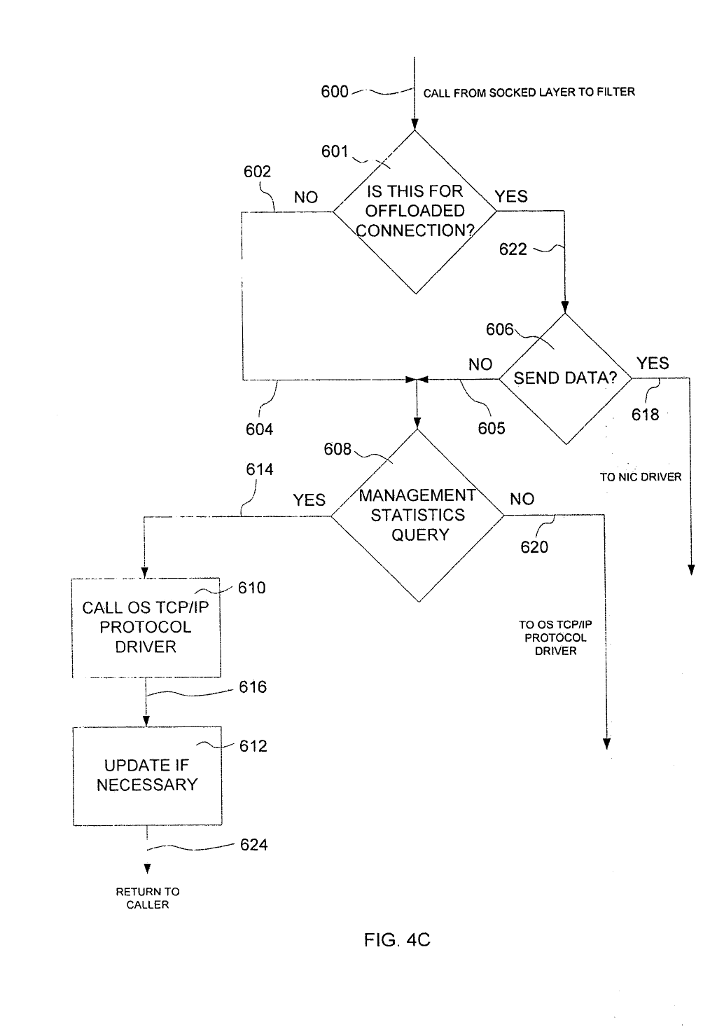

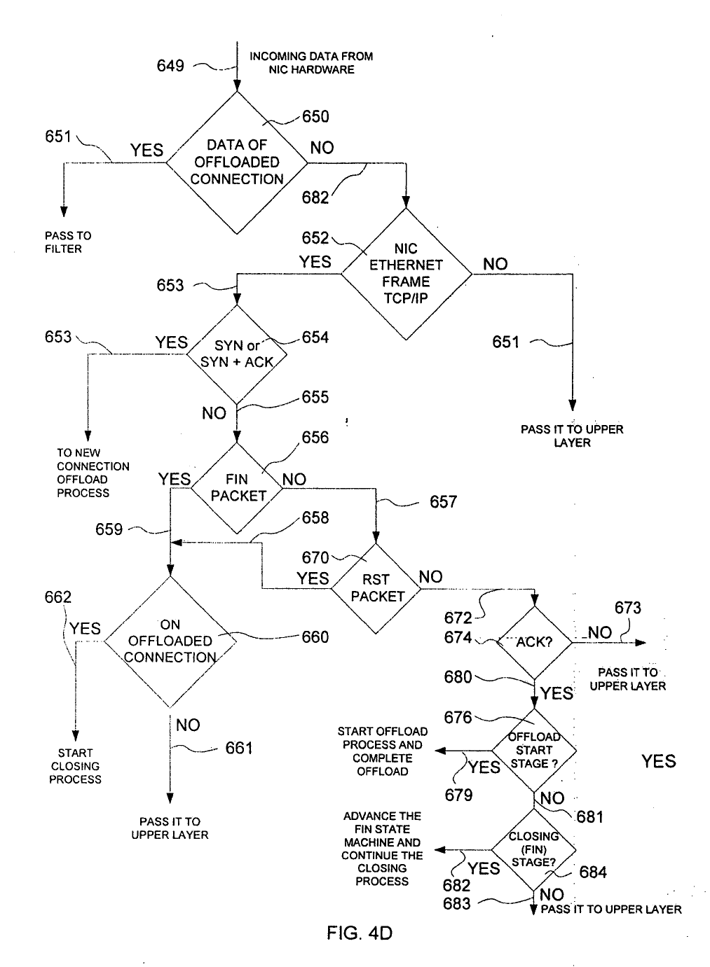

FIG. 4A illustrates, in accordance with another aspect of the present invention, a simplified diagram showing a sequence transactions for a TCP connection, in which data is sent from a client, which comprises one embodiment of the present invention, to a server. For instance, an FTP application uploading a file onto a FTP server. The server portion of the diagram is shown in FIG. 4B.

The functional components shown in FIG. 3 are consolidated and presented horizontally as five aggregate components for the purposes of illustration. The user application 302 is shown as application 402. The socket library 306 and kernel mode socket library 312 are consolidated into socket layer 408. The TCP/IP filter driver 360 is shown as filter 414. The TCP/IP protocol driver 322 and the kernel functions/interface library 326 are consolidated into TCP/IP protocol driver 420. The NIC driver with TOE extensions 363 is shown as NIC driver 442. HAL 335, NIC H/W 336, the other protocol driver 318 are not shown, but assumed to be present in appropriate relationship to the other shown components.

Initially, the application 402 prepares the TCP/IP stack for a TCP connection through an open socket request. Application 402 requests an open socket 404a, from socket layer 408. The request, in turn, is passed to filter 414 at 404b, and finally to the TCP/IP protocol driver 420 at 404c. If the TCP/IP protocol driver 420 is able to open a socket, it passes an acknowledgement back to filter 414 at 406c, then to socket layer 408 at 406b, and finally to application 402 at 406a.

Many operating systems, other than Microsoft Windows, will then bind the socket to an address structure comprising the local IP address and the port number to be used for the connection. In Microsoft Windows, this is done by associating an “Address object” with the “connection object”. Application 402 requests a bind socket option 456a, from socket layer 408. The request, in turn, is passed to filter 414 through at 456b, and finally to the TCP/IP protocol driver 420 at 456c. If the TCP/IP protocol driver 420 is able to bind the socket, it passes an acknowledgement back to filter 414 at 454c, then to socket layer 408 at 454b, and finally to application 402 at 454a.

A connection can now be established with another device, in this case, the server shown in FIG. 4B. Application 402 requests a connection from socket layer 408 through the previously established socket, at 452a. The request, in turn, is passed to filter 414 at 452b, and finally to the TCP/IP protocol driver 420 at 452c. At this point, to the TCP/IP protocol driver 420 requests at 452d that the NIC driver 442 send out a SYN packet to the server. The SYN packet notifies the server that a client wishes to establish a connection, as well as conveys the parameters of the connection.

If the server accepts the request, it sends a SYN+ACK packet back. Upon receiving the SYN+ACK packet, the NIC driver 442 starts tracking the connection and accumulates TCP connection information needed for the offload (i.e., sequence number, window size, & time to live, etc.), and initializes the offload hardware. NIC driver 442 also informs filter 414 that the offload process is starting. That is, NIC driver 442 receives the packet and passes it to TCP/IP protocol driver 420 at 440. The TCP/IP protocol driver 420 then sends a first ACK packet back to the server to acknowledge that the SYN+ACK packet was received. This first ACK packet begins the offload process with the offload hardware.

Filter 414 then redirects data received from application 402 through socket layer 408 to the offload hardware, and subsequently to the server. Throughout the transfer process, the client sends ACK packets back to the server in order to optimize the packet throughput. Upon completion, the TCP/IP protocol driver 420 sends a final ACK packet to the server, and notifies filter 414 at 450c, then socket layer 408 at 450b, and finally the application 402 at 450a.

FIG. 4B illustrates, in accordance with another aspect of the present invention, a simplified diagram showing the server portion of the transaction shown in FIB. 4A.

The server, unlike the client, maintains an open socket to listen for incoming connection requests. Application 502 requests an open socket in which to listen at 510a, from socket layer 508. The request, in turn, is passed to filter 514 at 510b, and finally to the TCP/IP protocol driver 520 at 510c. If the TCP/IP protocol driver 520 is able to open a socket, it passes an acknowledgement back to filter 514 at 517b, then to socket layer 508 at 517a.

The server can now accept connections. In this case, it will accept a connection from the client shown in FIG. 4A. The NIC driver 552 receives a request to set up a connection from client, through the receipt of a SYN packet 530. This packet is sent to the TCP/IP protocol driver 520 at 521a.

TCP/IP protocol driver 520, on receipt of the SYN packet completes the Listen request from the application (510a) with a callback (524b, 524c and 524d). The application responds back with an accept transaction (546a). TCP/IP protocol driver 520 sends a SYN+ACK packet to the client (522a) and on receipt of the first ACK packet from the client (526, 524a) will acknowledge with an accept complete indication (544c/544b/544a) to application 502. That is, accept message transaction 546a is sent by application 502 to socket layer 508, which forwards it at 546b to filter 514, and finally to TCP/IP protocol driver 520 at 546c. TCP/IP protocol driver 520 responds with an accept complete transaction at 544c which is sent back to filter 514 at 544c, to socket layer 508 at 544b, and finally to application 502 at transaction 544a.

The client, after the first ACK packet that completed the handshake, then begins to send ordered IP packets to NIC driver 552. These packets are then forwarded to the TCP/IP protocol driver 520.

FIG. 4C illustrates, in accordance with another aspect of the present invention, a simplified diagram showing a sequence steps used by the TCP/IP filter driver to monitor and offload an outgoing TCP connection. Initially, a call is received from the socket layer on behalf of the user application at 600. The TCP/IP filter driver examines the transport handle and determines if the associated connection is an offloaded connection at 601. If yes 622, the filter driver further examines the type of the request to see if it is a data transfer request at 606. If yes 618, the request is forwarded to the offload hardware, using the NIC driver's TOE extensions. If no 605, or if the connection is not an offloaded one at 602, then it is examined to determine if it is a request for management statistics 608. If yes 614, the connection is forwarded to the OS TCP/IP protocol driver 610, and then TCP/IP filter driver information is updated 612. If no, then forward the connection to the OS TCP/IP protocol driver.

Per connection information (i.e., number of frames sent/received, number of retransmissions, etc.) is an example of management statistics query. There are also global protocol level statistics request that are not associated with any connection (Query and Set Protocol Information API) that also have to be handled correctly by a filter driver (that is, the request passed on to the underlying TCP/IP protocol driver and on the way back to the application may need to be updated by the filter driver).

FIG. 4D illustrates, in accordance with another aspect of the present invention, a simplified diagram showing a sequence steps used by the NIC driver to monitor and offload an incoming packet. Initially, a packet is received from the server at 649. The NIC driver determines if the packet contains both data and an associated offload transport handle at 650.

If yes 622, the packet is passed to the TCP/IP protocol filter at 651. If no at 682, it is further examined to determine if it is a TCP/IP packet at all, at NIC Ethernet frame TCP/IP 652. If no, the packet is forwarded through kernel functions/interface library to the correct protocol driver at 651. If yes 653, the TCP/IP packet is examined to determine if it is a SYN or a SYN+ACK packet at 654. That is, if the packet is for trying to establish a TCP connection.

If yes 653, the packet is forwarded to the new connection offload process. If no 655, it is examined to determine if it is a FIN packet 656. That is, if the packet is attempting to close the connection. If no 657, then the packet is examined to determine if it is a RST packet at 670. That is, if it is attempting to reset the connection because of some failure.

If yes 670, or if the packet is a FIN packet 659, then the NIC driver determines if there is an offload transport handle associated with the packet at 660. If yes 662, then it is forwarded to the connection closing process. If no 661, the packet is passed to through the kernel functions/interface library to the upper networking layers.

Referring back to the RST packet examination 670, if no 672 the packet is examined to determine if it is an ACK packet 674. If no 673, the packet is passed to through the kernel functions/interface library to the upper networking layers. If yes 680, the NIC H/W determines if this ACK packet is for a connection establishment handshake (ACK for a SYN+ACK) or if it is for closing a connection (ACK for a FIN+ACK) at 676. If no 679, the packet is passed to through the kernel functions/interface library to the upper networking layers. If this is for connection establishment, then the packet is forwarded to the offload complete process, else if this is for connection close, connection close state is entered.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. A method for optimizing a network connection between a first device and a second device, said first device comprising a first packet protocol and a second packet protocol, said first packet protocol comprising a connection setup portion, said second protocol comprising a data transfer portion, comprising:
initiating said network connection from said first device to set second device using said first packet protocol;
receiving an acknowledgement from said second device; and,
initiating a data transfer between said first device and said second using said second packet protocol.

2. The method of claim 1, wherein said first packet protocol comprises a transport protocol.

3. The method of claim 2, wherein said first packet protocol comprises TCP.

4. The method of claim 3, wherein said first packet protocol comprises a transport protocol other than TCP.

5. The method of claim 1, wherein said first device comprises an operating system, said operating system comprises said first packet protocol.

6. The method of claim 1, wherein said second packet protocol comprises a transport protocol.

7. The method of claim 6, wherein said second packet protocol comprises TCP.

8. The method of claim 7, wherein said second packet protocol comprises a transport protocol other than TCP.

9. The method of claim 1, wherein said first device comprises an integrated circuit, said integrated circuit comprises said second packet protocol.

10. The method of claim 9, wherein said first device comprises a computer component card, said computer component card comprises said integrated circuit.

11. The method of claim 10, wherein said computer component card is a PCI card.

12. The method of claim 31, wherein said computer component card is a PCI-X card.

13. A apparatus for optimizing a network connection between a first device and a second device, said first device comprising a first packet protocol and a second packet protocol, said first packet protocol comprising a connection setup portion, said second protocol comprising a data transfer portion, comprising:
means for initiating said network connection from said first device to set second device using said first packet protocol;
means for receiving an acknowledgement from said second device; and,
means for initiating a data transfer between said first device and said second using said second packet protocol.

14. The apparatus of claim 1, wherein said first packet protocol comprises a transport protocol.

15. The apparatus of claim 2, wherein said first packet protocol comprises TCP.

16. The apparatus of claim 3, wherein said first packet protocol comprises a transport protocol other than TCP.

17. The apparatus of claim 1, wherein said first device comprises an operating system, said operating system comprises said first packet protocol.

18. The apparatus of claim 1, wherein said second packet protocol comprises a transport protocol.

19. The apparatus of claim 6, wherein said second packet protocol comprises TCP.

20. The apparatus of claim 7, wherein said second packet protocol comprises a transport protocol other than TCP.

21. The apparatus of claim 1, wherein said first device comprises an integrated circuit, said integrated circuit comprises said second packet protocol.

22. The apparatus of claim 9, wherein said first device comprises a computer component card, said computer component card comprises said integrated circuit.

23. The apparatus of claim 10, wherein said computer component card is a PCI card.

24. The apparatus of claim 10, wherein said computer component card is a PCI-X card.
